(19) United States
(12) Patent Application Publication
(10) Pub. No.: US 2012/0097741 A1
(43) Pub. Date: Apr. 26, 2012

(54) WEAPON SIGHT

(76) Inventor: Philip B. Karcher, Sarasota, FL (US)

(21) Appl. No.: 13/281,318

(22) Filed: Oct. 25, 2011

Related U.S. Application Data
(60) Provisional application No. 61/406,460, filed on Oct. 25, 2010.
(60) Provisional application No. 61/406,473, filed on Oct. 25, 2010.
(60) Provisional application No. 61/444,977, filed on Feb. 21, 2011.
(60) Provisional application No. 61/444,981, filed on Feb. 21, 2011.
(60) Provisional application No. 61/545,135, filed on Oct. 8, 2011.

(51) Int. Cl. G06G 7/80

(52) U.S. Cl. 235/404

(57) ABSTRACT

A system, apparatus and method providing a Processor Aided Weapon Sight (PAWS) for augmenting target environment information associated with an optical weapon sight.

### CROSS-REFERENCE TO RELATED APPLICATIONS

This application claims the benefit of provisional patent application Ser. Nos. 61/406,460, filed on Oct. 25, 2011, 61/406,473, filed on Oct. 25, 2010, 61/444,977, filed on Feb. 21, 2011, 61/444,981, filed on Feb. 21, 2011 and 61/545,135, filed on Oct. 8, 2011, all entitled WEAPON SIGHT, which provisional patent applications are incorporated herein by reference in their entireties.

### FIELD OF THE INVENTION

The invention relates generally to systems, apparatus and methods for augmenting target environment information associated with an optical weapon sight.

### BACKGROUND

High accuracy is critically important for long range engagements where small angular inaccuracies combined with environment effects can lead to rifle rounds or other ordnance missing intended targets. Successful ballistic correction is a requirement when shooting at distant targets. Traditional ballistic calculation processes can be very effective in determining the correct aim point of the weapon, however the time required to set up for an initial shot can be lengthy when compared to the compressed time scales required for certain engagements. In today's combat environment this time can be critically important to both the lethality of the engagement as well as the survivability of the war fighters or sniper team.

### SUMMARY

Various embodiments of a system, apparatus and method associated with a processor aided weapon sight (PAWS) are provided herein.

One embodiment comprises a weapon sight including a beam splitter, for combining objective scene imagery received on a primary viewing axis with heads up display (HUD) imagery to produce a merged image for propagation towards a viewing point along the primary viewing axis; a presentation device, for generating the HUD imagery; and a computing device, for processing ballistics relevant data and responsively causing the presentation device to adapt an aiming reticle included within the HUD imagery. In various embodiments, the presentation device comprises an imager formed using one of a micro transmissive LCD display and a MEMS micro-mirror array, where the imager is operatively coupled to the computing device and adapted thereby to provide the HUD imagery.

### BRIEF DESCRIPTION OF THE DRAWINGS

The various embodiments discussed herein can be readily understood by considering the following detailed description in conjunction with the accompanying drawings, in which:

FIG. 1 graphically depicts front and back views of one embodiment;

FIG. 2 graphically depicts an exploded view of one embodiment;

FIG. 3 graphically depicts a technique for tracer round tracking;

FIG. 4 graphically depicts an exemplary heads-up direct view of a target scene;

FIG. 5 graphically depicts an exemplary configuration drop-down menu;

FIG. 6 graphically depicts an exemplary target GPS and direction display;

FIG. 7 graphically depicts an exemplary extended targeting mode;

FIG. 8 graphically depicts the day/night embodiment;

FIG. 9 graphically depicts an embodiment mounted on a rifle;

FIG. 10 depicts a high-level block diagram of a computer suitable for use in performing functions described herein;

FIG. 11 depicts a high-level block diagram of an embodiment of a PAWS computing device;

FIGS. 12-13 depict respective embodiments of a Dual Source Lighting with Micro-Mirror HUD Apparatus and Method;

FIG. 14 graphically depicts an orthogonal view of a clip-on embodiment;

FIG. 15 depicts a high-level block diagram of a clip-on embodiment;

FIG. 16 depicts a laser range finding compact module according to one embodiment;

FIG. 17 provides several views of a clip-on device according to one embodiment;

FIG. 18 depicts a high-level block diagram of a simplified rear mount/clip-on device according to one embodiment; and

FIG. 19 provides several views of a clip-on device according to one embodiment.

To facilitate understanding, identical reference numerals have been used, where possible, to designate identical elements that are common to the figures.

### DETAILED DESCRIPTION OF THE INVENTION

Various embodiments will be described primarily within the context of a standalone weapons sight including a specific set of features and capabilities, as well as “clip-on” devices mounted in front of or to the rear of an existing optical weapon sight and adapted to provide some or all of the specific set of features and capabilities in conjunction with the existing optical weapon sight.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

Overview

Various embodiments of systems, apparatus and methods providing a Processor Aided Weapon Sight (PAWS) to aid the combatant in achieving the highest level of firing accuracy are provided herein. Various embodiments include some or all of the following advanced capabilities:
Operational sighting and ranging capabilities out to 2500 meters. Direct-view optical capability.
Real time ballistic solution processing. Fully integrated ballistic computer.
Integrated heads-up display overlaid onto optical scene for advanced targeting.
Integrated near infrared Laser Rangefinder.
Immediate automatic next round ballistic correction through in-flight tracer round detection and tracking.
Weapon pointing angle tracking using integrated high performance inertial sensors. Ability to make precise pointing angle comparisons for advanced ballistic targeting and correction.
Integrated GPS and digital compass. Sight is capable of full coordinate target location and designation.
Integrated sensors for pressure, humidity, and temperature. Sight is capable of automatically incorporating this data in ballistic calculations.
Conventional rifle scope capabilities in all conditions, including zero-power off mode.
Wired and wireless interfaces for communication of sensor, environmental, and situational awareness data. Ability to support digital interfaces such as Personal Network Node (PNN) and future interfaces such as Soldier Radio Waveform (SRW).
Anti-fratricide and situational awareness data can be processed by the device and viewed while sighting using the integrated head-ups display.
Scope capable of reticle targeting correction beyond scopes field of view for convenient ballistic drop correction at long ranges.
Scope has integrated tilt sensitivity with respect to vertical. In device ballistic correction possible for uphill and downhill shooting orientations.
Ability to upload weapon, round, and environmental characterization data to the weapon sight using a standard computer interface.
Integrated imaging sensor. Device capable of acquiring and processing target scene image frames. Additional advanced capability possible through algorithmic development.
Ability to record firing time history for purposes of applying cold bore/hot bore shot correction in an automated fashion.
Built in backup optical range estimation capability with automatic angular to linear size conversion provided on heads-up display.
Simplicity of design ensures minimal training for optimum shooter performance.
   A day/night version of PAWS incorporates some or all of the following additional features:
Integrated Night Vision capabilities using Gen III image intensifier. Automatic and seamless transition from dark to light capability. Direct view zero-power daylight sighting preserved. Fused visible light and near IR scene display.
Increased sensitivity for ballistic tracer round tracking using image intensifier.
Smart anti-blooming image display.
Integrated near IR Laser illuminator.

In one embodiment, the Processor Aided Weapon Sight (PAWS) provides an integrated weapon sight that can be mounted to a 1913 Picatinny Rail on a host of long range, semi-automatic rifle weapon platforms (e.g. XM500, M107, M110, etc.). In addition the sight can also be adapted for use with crew served weapon system and other weapon types. The sight is designed to be a self contained electro-optical device that incorporates optics, sensors, processing electronics, and power into one unit providing situational awareness and data communications capabilities. Various embodiments of the weapon sight described herein may be adapted for use in conjunction with a daylight vision scope, a twilight vision scope, a night vision scope and the like. Moreover, various night vision weapon sights may be adapted according to the teachings herein.

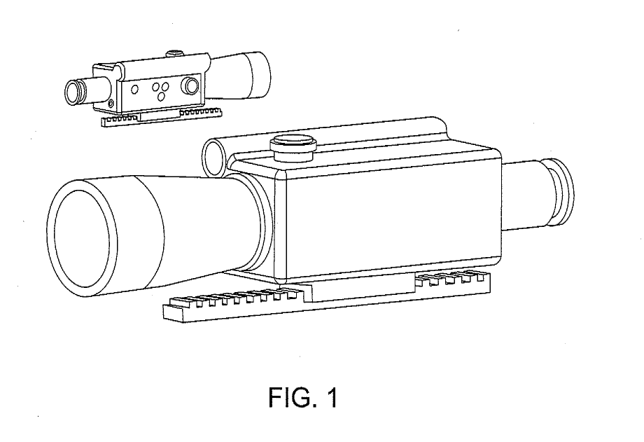

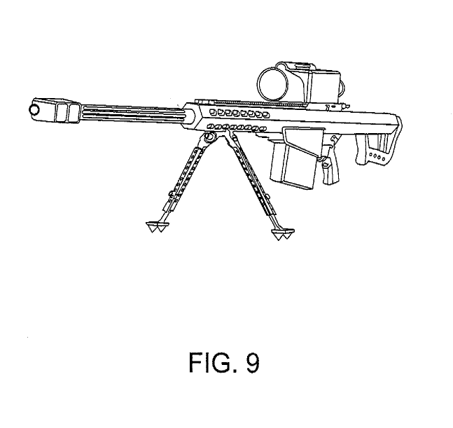

FIG. 1 graphically depicts front and back views of one embodiment. FIG. 9 graphically depicts an embodiment mounted on a rifle, illustratively an M107 rifle.

High accuracy is critically important for long range engagements where small angular inaccuracies combined with environment effects can lead to rounds landing off their mark. Successful ballistic correction is a requirement when shooting at distant targets. Although the traditional ballistic calculation processes can be very effective in determining the correct aim point of the weapon, the time required to setup for the initial first shot can be lengthy when compared to the compressed time scales required for certain engagements. In today's combat environment this time can be critically important to both the lethality of the engagement as well as the survivability of the sniper team.

The various embodiments discussed herein bring the ballistic calculation process into the weapon sight itself. These embodiments merge substantially real time ballistic processing and sensor data collection to provide an automatic ballistic reticle correction ability that the shooter can quickly use to make highly accurate shots. These embodiments can reduce the time required for long range first shot setups to only a few seconds, bringing an effective long range “stop and shoot” capability to a variety of potential weapons, including the modern generation of long range, semi automatic sniper rifles such as the XM500, M107, and M110.

Various embodiments provide an advanced weapons sight that incorporates the ability for a combatant to quickly and accurately fire a sniper weapon or crew served weapon at distant targets.

### PAWS Weapon Sight and Related Embodiments

The various embodiments discussed herein provide many unique features. As a day scope it preserves the high resolution and fidelity of viewing the target scene with the human eye while simultaneously providing real time ballistic calculation, sensor data collection, advance image processing, and in scope heads-up status display.

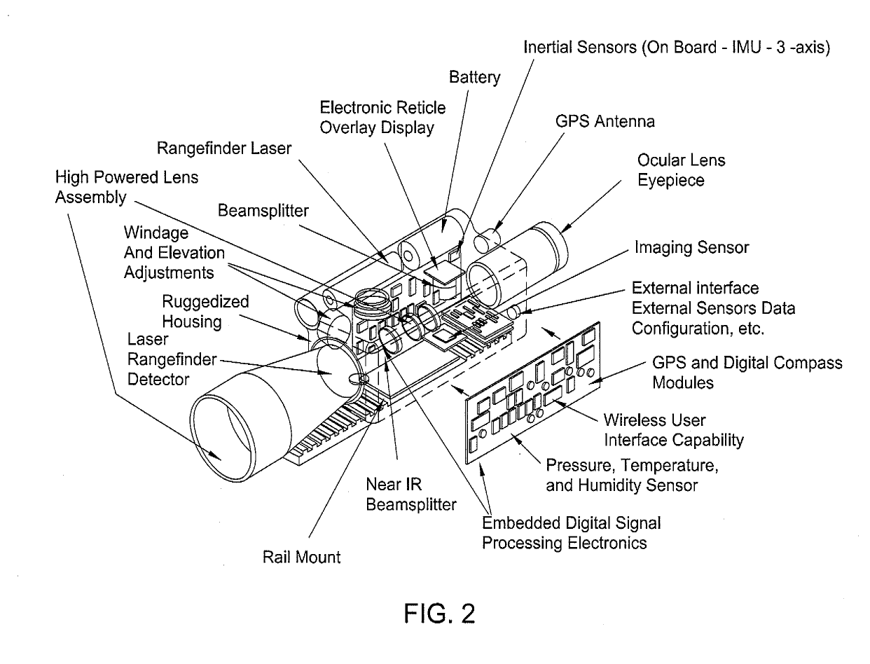

FIG. 2 graphically depicts an exploded view of one embodiment. Specifically, as shown in FIG. 2, the weapon sight or scope integrates embedded processing boards, image sensor, inertial sensors, environmental sensors, laser rangefinder, digital compass, GPS, and an electronic micro LCD display with standard passive optical viewing components. The micro LCD display is used to overlay a heads-up display capability onto the optically viewed object scene. All components are integrated into a small footprint ruggedized housing that has an integrated rail mount. In addition, data gathered is also available to be shared for situational awareness through a standard data port designed into the device.

### Optics

Optic geometry along the primary viewing axis of the sight is similar to other conventional riflescopes. In various embodiments, the weapon sight provides both front and rear focal planes. The rear focal plane contains a conventional reticle and is also the focal plane for the rear eyepiece lens assembly thus creating an afocal optical system. In between the front and rear focal planes are relay and erecting lens. The scope has a standard eye relief of about 3.5 inches. The magnification of the scope is determined in response to usage requirements. Although not shown for brevity, the optical design can also support a zoom capability. Optical elements may have anti-reflection coatings to maximize optical transmission through the device.

Other components are integrated to support the sight's advanced functionality. Along the primary optical path, a near IR beamsplitter optimized to the laser wavelength is placed ahead of the front focal plane to support laser rangefinder receiver functionality. Just ahead of the rear focal plane, a broadband beamsplitter is added. An image sensor is located below the beamsplitter in the focal plane created by splitting the primary optical axis.

Above the beam splitter is a micro LCD module and associated optics that focus the heads-up display information onto both the reticle focal plane and the imaging sensor. If the heads-up display is configured to only have blue color output, the option exists in the design to insert a blue blocking filter in front of the image sensor to suppress heads-up display light from reaching the sensor. The transmission/reflectance spectral characteristics of both the broadband and near IR beam-splitters may be determined with respect to operational requirements. The central optical elements including the imaging sensor and micro LCD assembly are, in some embodiments, mounted on an internal framework (not shown). In various embodiments, the windage and elevation adjustments move this framework in a manner similar to how a conventional riflescope functions to achieve the necessary angular offsets that are desired for alignment and configuration.

The imaging sensor are selected based on sensitivity, resolution, and performance requirements. It supports the ability of the scope to track tracer bullet trajectory by detecting light from the tracer as it moves downrange. Since the COD has a dedicated optical path, the sensor's electronic shuttering and readout can be optimized for tracer detection when it is operating in this mode. Video from the CCD can also be used to perform sophisticated image processing to support a variety of advanced recognition and tracking functions.

### Electro-Optics

Various embodiments provide an integrated heads-up display capability made possible by a high resolution micro LCD display that is positioned above the beamsplitter. A lens assembly between the micro LCD and the beamsplitter element allows the micro LCD image to be focused on the focal plane of the reticle so the optical image view of the target can be overlaid with status information from the display. In various embodiments, the scope's direct view reticle is of etched glass type and is visible at all times.

In various embodiments, the direct view scene, the focal plane array imagery, and the micro LCD are spatially registered and scaled to each other. This allows measurements made with image sensor data to be spatially referenced to the optical scene. Likewise, the micro LCD can display location information at the appropriate reference point in the direct view scene. In addition to showing a dynamic ballistic reticle, this targeting display can support a rich array of additional features. This includes displaying sensor data gathered by PAWS and displaying target locations obtained from external situational awareness systems.

### Pointing Angle, Target Location, and Communication

To determine the pointing angle of the weapon in inertial space, various embodiments of a weapon sight incorporate small low cost inertial MEMS Rate Sensors, which are available in small form factor packages that are ideal for embedded applications. Example products are the LCG-50 by Systron Donner and the SiRRS01 by Silicon Sensing. Both these products have very low random walk noise and are desirable for applications where the angular rate is integrated to determine pointing angle. In addition to the rate sensors, small chip size accelerometers are preferably incorporated into the embedded electronics to determine absolute tilt angle of the weapon sight and track weapon accelerations due to general movement or a firing event.

To support targeting, in various embodiments a GPS and digital compass are integrated into the device. These devices may be integrated as, illustratively, board level modules. Several manufacturers offer COTS modules for GPS and digital compass functionality that are small form factor and have low power consumption characteristics. These devices are designed to be integrated into embedded components. For example, Ocean Server Technology makes a OS4000-T compass with 0.5 deg. accuracy and has a power consumption under 30 ma and is less than ¾″ square. An example of a GPS device is the DeLorme GPS2058-10 Module that is 16 mm×16 mm and is available in a surface mount package offering 2 meter accuracy.

Various embodiments incorporate a data interface that provides one or both of wired and wireless capabilities designed to interface to systems such as the BAE Personal Network Node and the emerging SRW radio. These interfaces provide various communications capabilities, such as range, sensor, and other tactical data (e.g. anti-fratricide detector, environmental sensors, etc.). This unique functionality is used in various embodiments to obtain and communicate environmental, target, and situational awareness information to the community of interest. Generally speaking, the various embodiments are designed to enable the war fighter to quickly acquire, reacquire, process, and otherwise integrate data from a variety of passive and active sources into a ballistic firing solution thereby increasing the shooter's effectiveness.

### Laser Range Finder

Various embodiments utilize a laser range finder to accurately determine distance to target. The laser range finder is integrated into the scope and has a dedicated outgoing laser transmission port. The optical path of this dedicated laser axis is positioned in the corner of the housing so it is unobstructed by the main objective lens. The detection path for the incoming reflected laser signal is through the main objective of the scope where the light is directed to a photo detector by a near IR beamsplitter. This arrangement takes advantage of the relatively large aperture of the main objective lens to increase the signal to noise of the measurement. In various embodiments, the laser transmits in the near IR for covertness. A typical wavelength used for laser rangefinder devices operating in the near infrared (NIR) is 905 nm. This is the wavelength designed into one embodiment of the system; other embodiments use other wavelengths, duty cycles and so on as described in more detail below.

In various embodiments, the specific laser power and spectral characteristics are selected to meet range and eye safety requirements of the device. The rangefinder is of sufficient power to produce accurate measurements out to, illustratively, 1500 meters, 2500 meters or whatever effective range is associated with the rifle or other weapon intended to be used with the weapon sight.

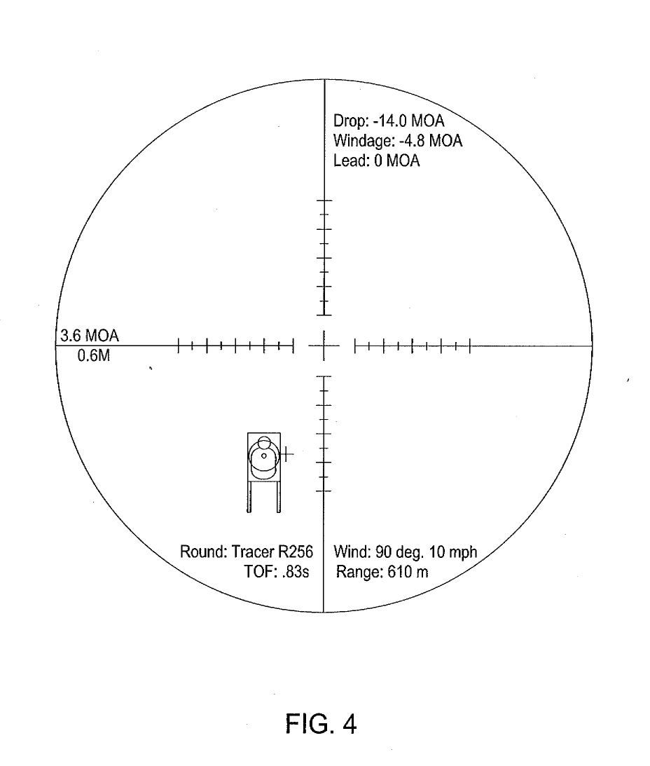

For rangefinder operation, in some embodiments a single button control is dedicated for making or executing a rangefinder measurement. Options for operation of the rangefinder are optionally shown on the sight's heads up display. The range to target may be prominently displayed when viewing the target scene, such as depicted in FIG. 4.

Various embodiments having an integrated laser range finder capability provides dynamically defined ballistic solutions based upon data acquired. The range to target may be used by the on-board computer when processing tracer trajectory to determine the best point along the measured trajectory path to use for determining the ballistic correction for the next shot.

### Environmental Sensors

Integrated into various embodiments are pressure, humidity, and/or temperature sensors designed to collect and use environmental data for ballistic correction purposes. The sensors are available in miniature configurations suitable for integration into embedded systems. An example of a miniature, low power, water proof, barometric pressure sensor is the MS5540 from Intersema. This component measures 6.2×6.4 mm.

### User Controls

Various embodiments of the weapon sight function as an advanced ballistic computer to be used to determine the first round hit solution when firing at Sniper distances. Since much of the ballistic data is, in various embodiments, pre-loaded in a tabular format (illustratively), in some embodiments the user interface for the weapon sight comprises a relatively small control area containing only a few buttons on the body of the device, which buttons provide various setup and configuration capabilities. Manual windage correction adjustments, mode selection, ammunition type, and other configuration controls may be accomplished through a relatively simple, easy to use interface while in the field. Control buttons on the various embodiments of the PAWS system may be used in conjunction with the heads up display so that scope and manual ballistic settings can be configured.

In various embodiments, PAWS configuration and parameter changes may also be made utilizing the wired interface. Ballistic, operator, environmental, and gun specific information can be uploaded to the PAWS platform at any time.

### Tracking Bullet Trajectory

One of the difficulties associated with long range engagements is the ability to determine the accuracy of the initial shot so that a timely correction can be made to improve the accuracy of the next shot. A traditional technique used to determine the round's point of impact is to attempt to detect bullet trace and/or actual splash point of bullet. This can be difficult in many long range engagements. In the case of a sniper team, the follow up shots also require feedback from the spotter to get the pertinent data back to the shooter. This can take several seconds using only verbal communications.

Some embodiments allow tracer rounds to be detected by on-board image processing capabilities so as to determine the bullet's trajectory just before it impacts the target area. This data is then communicated back into the ballistics computer thereby quickly and efficiently creating a follow up firing solution for the second round.

Automating the feedback loop with trajectory and splash point detection by computer and combining this with an electronic reticule correction advantageously decreases the total time required to make an accurate second shot. This time reduction can be at a critical point in the engagement process. After the first shot is made, the window of opportunity to make a second shot can quickly narrow, especially if delays extend past the point in time when the sonic boom of the initial shot reaches the intended target.

Environmental conditions and windage drifts can have substantial impact on the ballistic trajectory of the round over large distances. For instance a M193 bullet can drift about 4 feet in a modest 10 mph crosswind at 500 yards. Windage effects become even more exaggerated at greater distances since the speed of the bullet decreases as the range and total time of flight increases.

### Use of Covert Tracers

A variety of tracer round options are available to the war fighter today. A standard tracer is used conventionally by the shooter to see the trajectory of the bullets in-flight path. A tracer round can emit light in the visible or IR spectrum depending on the composition of the tracer material. The latter is effective when the shooter is using night vision equipment. In addition some tracers can emit light dimly at first and then brighten as the round travels downrange. A fuse element can control when the tracer lights up after firing of the round in order to delay igniting the tracer material until the bullet is well downrange. The fuse delay mitigates the risk of the tracer revealing the shooter's firing location.

Various embodiments allow tracer rounds to be detected by the image processing capabilities of the system so as to determine a bullet's trajectory just before it impacts the target area. Of particular interest is the use of covert tracers that have long delay fuses and emit in the near IR region (700 nm to 1000 nm) of the electromagnetic spectrum. Light emitted in the near IR region is invisible to the human eye, but can be detected by an imaging sensor using conventional glass optics. A tracer round of this type can be particularly effective in maintaining the shooter's covertness for Sniper operations while providing a significant automated bullet tracking capability for accurately determining next shot correction requirements. Thus, various embodiments are adapted to cooperate with one or more types of tracer rounds to implement the functions described herein.

Since the imaging sensor in the daylight scope embodiment is also sensitive to visible light, a standard daylight tracer can also be used for bullet tracking. In both the visible and near IR cases, the tracer rounds can take advantage of having long delay fuses to increase covertness as PAWS only needs to detect the bullet's flight in the final moments before impact.

### Ballistic Tracking

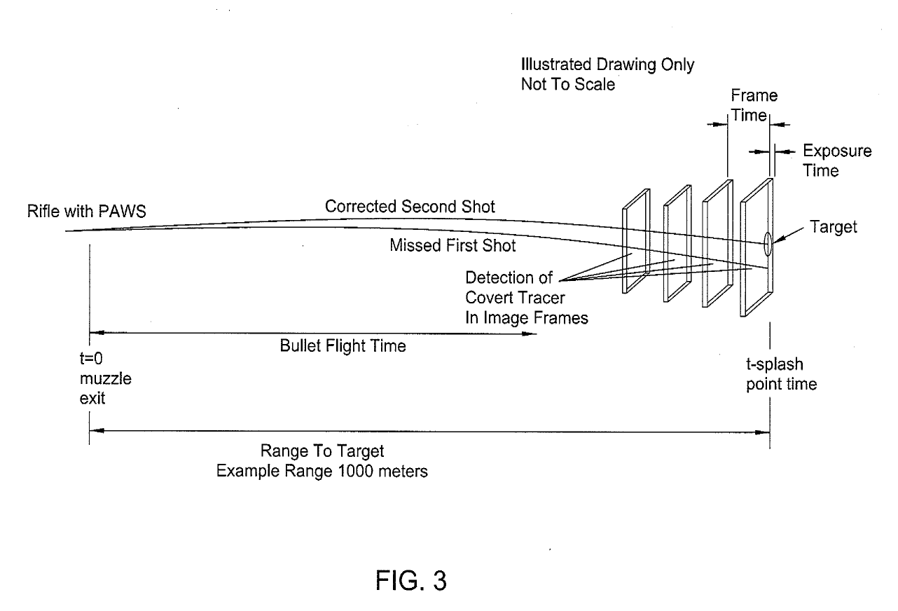

The tracking of the bullet's trajectory is depicted in FIG. 3. The technique incorporates capturing video frame images of the glowing tracer bullet in flight. The spatial location of the bullet in selected image frames is extracted through image processing techniques and then correlated with data from other video frames to establish the bullet's trajectory.

Image frames are selected for processing based on correlation with the firing event. When the round is fired from the weapon, the time of muzzle exit is immediately determined by processing accelerometer data obtained from an on-board weapon axis accelerometer included in various embodiments. A correlation window from the time of muzzle exit is then started where various embodiments begin frame by frame processing of video images to identify therein a small cluster of pixels associated with the tracer round at a particular X-Y position in space. The frame images may be taken with an exposure time that is optimized to capture the bullet as it transmits a small number of individual pixels in the X-Y frame. Since the frame rate of the camera and time of muzzle exit is known, the bullet's distance from the weapon in each frame can be established using the known flight characteristic of the bullet. This data is contained in the onboard tables pertinent to each weapon and its associated rounds or, alternatively, received from a tactical network communication with the weapon sight.

If an absolute range to target is known from a laser rangefinder measurement, the position of the round at the target range can be calculated by determining the point in the trajectory that corresponds to the target range. The elegance of this technique is that the measurement is done from in-flight data and does not rely on bullet impact with a physical surface. The position calculated would correspond to an angular elevation and azimuth relative to the weapon's position and can be used to determine the ballistic pointing correction needed for increased accuracy. As part of this next shot ballistic correction calculation, various embodiments use inertial pointing angle data to calculate the relative reference point between inertial pointing angle of the gun at muzzle exit and the pointing angle at the time of splash. This allows the calculation to take into account any angular movement of the gun that occurred during the bullet's time of flight to target range.

### Overview

The various embodiments discussed herein provide a multitude of advanced targeting functionality while preserving a direct view of the target scene. In its basic operational form PAWS functions as a conventional riflescope and can be used in this manner at any time, including when the scope is powered off. However, its primary mode of operation is in the power “on” state to access the scope's rich array of advanced features.

### Heads-Up Display

The PAWS system and related weapon sight embodiments incorporate a micro LCD display or other display allowing text and graphics to be overlaid onto the direct view scene. This display is electronically controlled and can show live status information with reticles for targeting and aiming.

FIG. 4 graphically depicts an exemplary heads-up direct view of a target scene as displayed to a shooter looking through the scope. The black reticle is the etched reticle that is a component of the riflescope's optics and, in various embodiments, is always be present for conventional aiming. The blue text and reticles are generated from the micro LCD display. The image scene is a direct view through the scope.

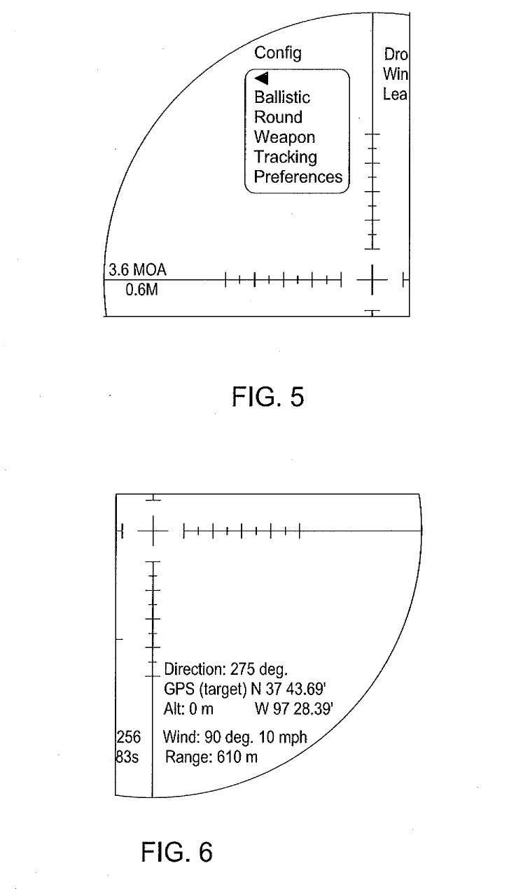

FIG. 5 graphically depicts an exemplary configuration drop-down menu. Specifically, the display supports a menu system that allows the user to configure the scope, setup ballistic information, and choose mode selections. This user interface is controlled by one or more buttons located in a convenient place, such as on the side of the scope or other place enabling easy user access. Since the heads-up display can support both graphics and text, the user interlace may incorporate icons for compactness. Actual selections can be pre-populated with choices from data uploaded by a computer during the scope's initial setup. For instance, the different round types and round characterization data can be uploaded to the scope prior to deployment so the menu displays the round types available for the given weapon configuration used with the scope.

### Ballistic Computer

Various embodiments calculate substantially immediate ballistics solutions using either on board sensor data or from user input. The calculation ability of the various embodiments is similar in fashion to a hand held ballistic computer a sniper team might use. Round and weapon characterization data can be pre-loaded via computer upload during the initial setup of the device. The integrated laser range finder allows range to be determined and automatically integrated into the ballistic solution.

Integrated into the sight are pressure, humidity, and temperature sensors that may be used by various embodiments to collect environmental data. Depending on the user configuration, various embodiments can be setup to automatically collect and use this data in its real time calculation of the ballistic solution. PAWS also has the ability to accept manual input of windage and elevation offset corrections per a given range setting.

Various embodiments have the ability to record firing time history for purposes of applying cold bore/hot bore shot correction in an automated fashion.

In one embodiment, in response to first user interaction such as a user pressing a particular button, the computing device enters a ranging mode of operation in which target related information associated with a presently viewed aiming reticle is retrieved and stored in a memory. This target related information may also be propagated to other network elements within the context of a tactical computer network.

In one embodiment, in response to a second user interaction such as a user pressing a particular button, the computing device enters a reacquisition mode of operation in which previously stored target related information is retrieved from memory and used to adapt reticle imagery to reacquire a target. This target related information may also be propagated to other network elements within the context of a tactical computer network.

### Sighting

The black crosshairs reticule shown in FIG. 4 is designed to represent a conventional sighting or aiming reticle for the scope. This aiming reticle can be manually adjusted with windage and elevation knobs located on the scope. Each major division of the reticle represents 3.6 MOA or 1 MIL. If the scope has variable magnification, this may be at the scope's highest magnification. This reticle is available to the shooter at all times even when the scope is in the power off mode.

The reticle representing the full ballistic correction is a blue circular sighting element with a center 0.5 MOA dot. This component represents the corrective aim point of the weapon given the known total ballistic corrections for the shot. It is calculated in real-time based on the correct settings for weapon, ammunition, and environmental characteristic that are programmed into the sight's onboard processor. By definition, this aim point reticle corrects for ballistic bullet drop. It can also separate from the black vertical line of its reticle counterpart if windage data, next round correction data, or relative motion information is available.

As with conventional reticle divisions, and outside circle of the sighting element represents 3.6 MOA or 1 MIL (if variable magnification, at the scopes highest magnification setting). Either of these elements can be used to confirm range if the size of the target is known. Various embodiments dynamically display the meter and angular equivalent sizes of the reticle divisions (and circle diameter) for the given range and scope magnification (See FIG. 4). This can be used to approximately measure range even if laser range finder information is not available since the operator can manually adjust the range setting until the 3.6 MOA division or circle diameter represents the correct linear size at the target.

Also depicted in FIG. 4 is a small blue “+” reticle. In various embodiments, if a tracer round correction was performed, the “+” reticle becomes a selectable option to show the corrected aim point based only on the physical parameters computed in the ballistic calculation without incorporating any correction based on tracking of the tracer round.

### Target Location

Various embodiment include an integrated GPS, digital compass, and/or laser rangefinder, it has the ability to extrapolate actual target GPS coordinates. In this mode, the operator would place the black reticle on the distant target and make a laser range finder measurement. Once the distance is known, this distance may be used with a compass direction to target and/or the GPS location of the war fighter to calculate the actual GPS coordinates of the target. These coordinates may be displayed on the heads-up display. If communication between the various embodiments and other tactical network elements is established, the target and/or war fighter coordinates may be digitally relayed to other battle field systems. An example display is depicted in FIG. 6.

### Long Range Shooting

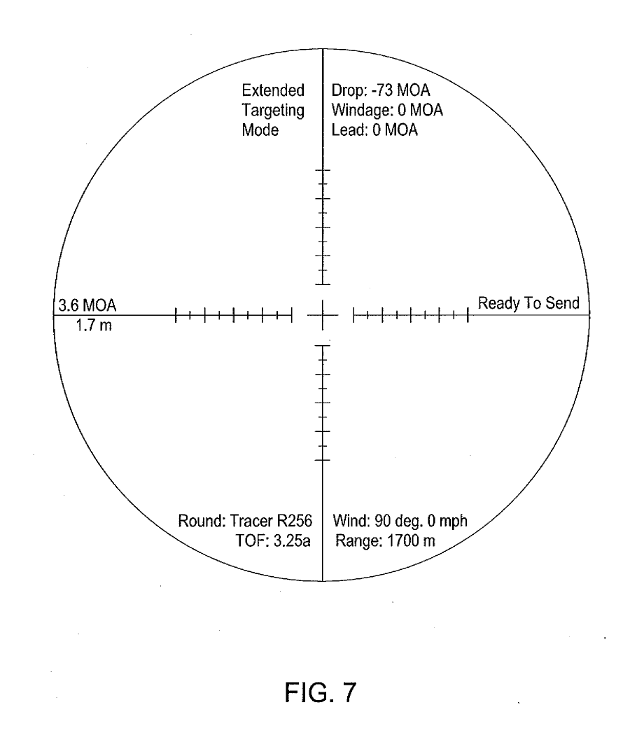

When engaging targets at long range, various embodiments provide the ability to ballistically target in an extended field of view mode (Extended Targeting Mode). At these ranges, the ballistic drop can be several hundred feet and outside the field of view of a highly magnified scope. This feature can allow the shooter to engage distant targets at 2000 meters and beyond by first designating the target with the primary black crosshairs reticle and then moving the scope upward past the current field of view until a blue square ballistic reticle appears. The ballistic reticle is one mil square and aligning the one mil notation of the black crosshairs over the ballistic reticle may denote the corrected aimpoint for the shot as depicted in FIG. 7.

This feature is enabled via, illustratively, inertial pointing capabilities in some embodiments. Since this mode uses inertial data to maintain the pointing references, it may have some small drift over time due to intrinsic sensor noise. However, this drift is low when utilizing high performance gyros and is typically not significant where target acquisition is performed within a reasonable amount of time. In this mode, the aim point also has the potential to being optically locked “in” for extended time durations if needed, either by the shooter taking a manual reference of where the ballistic aim point is located on the landscape or by the weapon sight performing an optical lock using image sensor data. A graphic representation of the optical lock event may be provided on the heads-up display.

### Uphill and Downhill

Various embodiments incorporate an integrated z-axis accelerometer that can be used to measure tilt angle of the scope with respect to vertical. This tilt angle can be integrated into the ballistic solution at the time of target selection. Once the target is selected, the system may be able to automatically integrate actual uphill or down tilt into the ballistic solution so the blue ballistic reticle is displayed correctly. This can provide for a very fast and effective means of aiming in long range uphill or downhill engagements.

### Day/Night

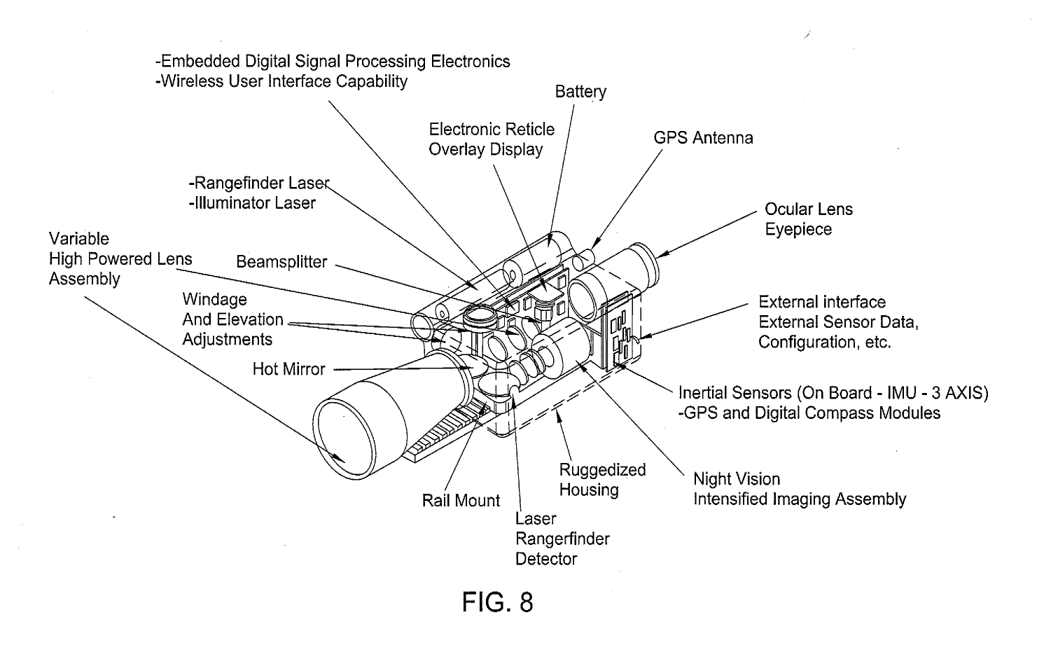

To incorporate a high performance night vision capability into the weapon sight or related platform, a third-generation image intensifier may be added in the configuration such as depicted in FIG. 8.

The image intensifier is, illustratively, fiber-optically coupled to a charge coupled device (COD) to provide an intensified COD (ICCD) night vision capability that is available on-demand. Various embodiments provide a ruggedized housing expanded in width to provide an additional optical path for the ICCD capability. It is noted that in various embodiments the primary components of the day scope embodiments are also included within the day/night version of the scope.

### Electro-Optics

To achieve day/night capability while still preserving the various feature set, in some embodiments a hot mirror is added to the primary optical path to redirect substantially all the non-visible (“hot”) near IR light and a portion of the longer wavelength visible light to the image intensifier. Since most of the reflected light energy during night time operations is in the IR, this allows the night imaging system to maximize the light collecting capabilities of the scope's aperture for these wavelengths. The beamsplitter passes almost all the visible light to the direct view optical system for day time imaging. The heads-up display beamsplitter in the rear of the device passes all red wavelengths and reflects slightly in blue and green. This acts to balance out color components for high fidelity direct viewing while supporting the heads-up display functionality. Note in this arrangement that zero-power direct view daylight sighting of the scope is preserved and the sight can revert to standard conventional scope capability if battery power is not available. To support laser rangefinder receiver functionality the secondary mirror in the IR optical path shown in FIG. 8 may have beam splitting properties to allow light of the specific laser rangefinder frequency to reach the laser rangefinder detector.

The scope in various embodiments has daytime variable magnification capability that is provided, depending on the design requirements, by rotating a magnification ring on the rear tube assembly or by a knob on the housing. Variable optical magnification of the image intensifier image can also be supported if desired. This would most likely be supported by a small micro motor since it can allow for automatic magnification matching between the direct view and image intensification sub systems. Without variable night vision magnification, it is envisioned that the magnification in some embodiments will be fixed at one of the lower optical magnifications to provide for higher light collecting efficiency and to provide an increased field of view for ballistic tracer round tracking purposes. Exact magnification power specifications for various embodiments are selected based upon usage requirements.

When operating at night, registration of the night vision display with the dim direct view optical scene is accomplished through 1:1 magnification matching of the two images fused at the heads-up display beamsplitter. The predominant viewing component in night operations may be from intensified IR imagery shown on the micro LCD display since the visible light components would be dim. During the day, the visible light direct view imagery can be fused, if desired, with the image intensifier imagery representing near IR spectral components to enhance the optical view of the scene. This can be particularly useful when trying to improve contrast when viewing between buildings or in trees.

Various embodiments of the weapon site scope provide a standard eye relief of about 3.5 inches (though larger or smaller eye relieve may be provided). Optical elements may have anti-reflection coatings to maximize optical transmission through the device.

To support night operations, the day/night version of PAWS, has an integrated near IR laser illuminator to support illumination of objects in front of the scope and in the target area. The effective range of the laser illuminator is determined based on user requirements. With this capability invisible reflected light from the illuminated scene can be imaged through the image intensifier and then displayed on the microLCD display.

Ballistic tracer round tracking in the day/night version of PAWS may have increased optical sensitivity as a result of incorporating an image intensifier. The Image intensifier may be gated in time to maximize the signal from the tracer round as it passes through a given spatial pixel to reduce background light accumulation.

A system, method, computer readable medium, computer program product and so on for processing sensor data and the like to provide targeting information in the manner described herein will now be discussed.

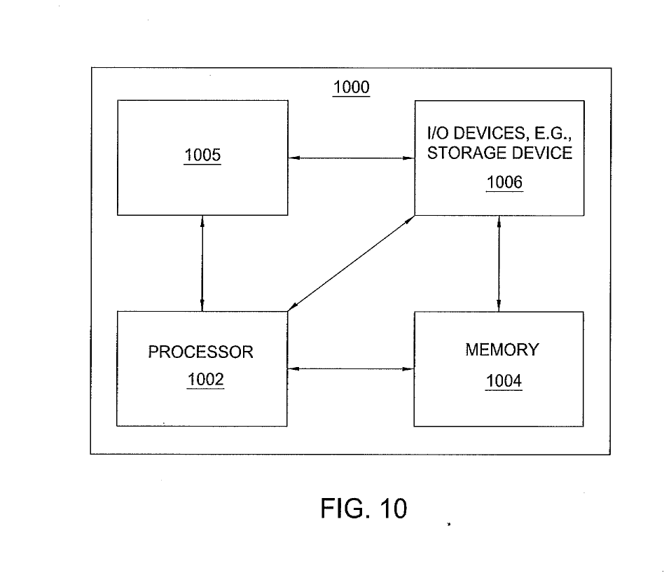

Specifically, FIG. 10 depicts a high-level block diagram of a computer suitable for use in performing the various functions described herein. As depicted in FIG. 10, a computer 1000 includes a processor element 1002 (e.g., a central processing unit (CPU) and/or other suitable processor(s)), a memory 1004 (e.g., random access memory (RAM), read only memory (ROM), and the like), a cooperating module/process 1005, and various input/output devices 1006 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 1005 can be loaded into memory 1004 and executed by processor 1002 to implement the functions as discussed herein. Thus, cooperating process 1005 (including associated data structures) can be stored on a computer readable storage medium, e.g., RAM memory, magnetic or optical drive or diskette, and the like.

It will be appreciated that computer 1000 depicted in FIG. 10 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a tangible or intangible data stream in a broadcast or other signal bearing medium, and/or stored within a memory within a computing device operating according to the instructions.

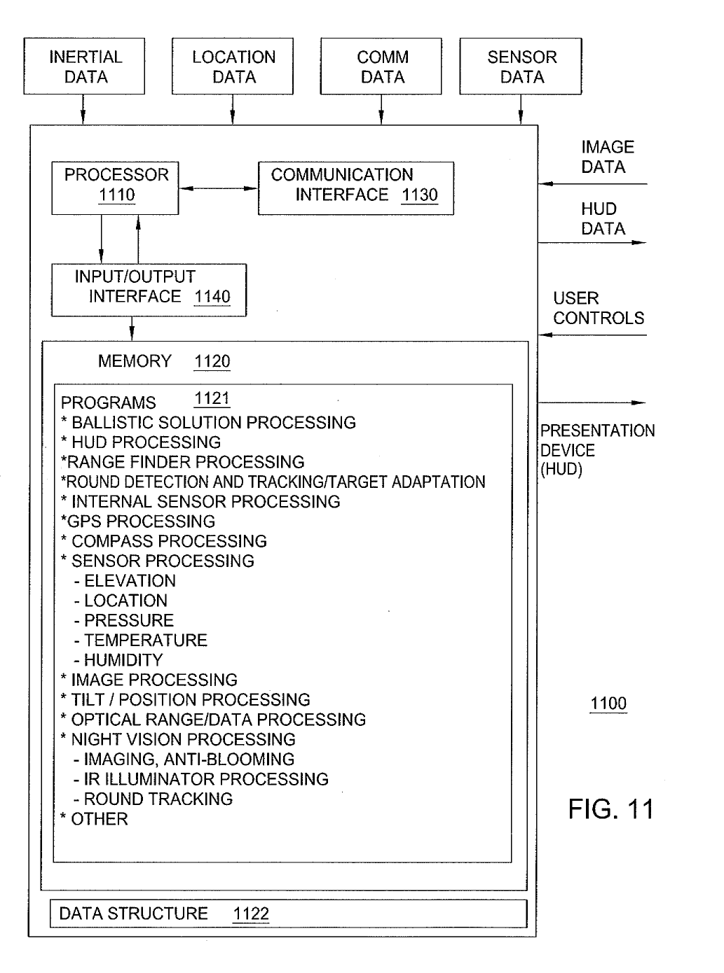

FIG. 11 depicts a high-level block diagram illustrating one embodiment of a PAWS computing device suitable for use in the systems and apparatus described above with respect to the various figures.

As depicted in FIG. 11, the computing device 1100 includes a processor 1110, a memory 1120, communications interfaces 1130, and input-output (I/O) interface 1140. The processor 1110 is coupled to each of memory 1120, communication interfaces 1130, and I/O interface 1140. The I/O interface 1140 is coupled to presentation interface(s) for presenting information on computing device 1100 (e.g., a heads up display (HUD) layered upon or otherwise not in conjunction with the optical sights of the scope, or as part of a helmet/visor arrangement used by war fighters) and is coupled to user control interface(s) (e.g., sensors associated with optical sight adjustments, or standard input devices such as touch screen or keypad input devices) for enabling user control of computing device 1100.

The processor 1110 is configured for controlling the operation of computing device 1100, including operations to provide the processor assisted weapon sight capability discussed herein.

The memory 1120 is configured for storing information suitable for use in providing the processor assisted weapon sight capability. Memory 1120 may store programs 1121, data 1122 and the like.

In one embodiment, programs 1121 may implement processing functions associated with one or more of ballistic solution processing, heads-up display processing, rangefinder processing, round detection and tracking/target allocation processing, inertial sensor processing, global positioning system processing, compass processing, sensor processing such as elevation, location, pressure, temperature, humidity and the like, image processing, tilt/position processing, optical range/data processing, night vision processing such as imaging, anti-blooming, infrared illuminator and round tracking processing, as well as other processing functions.

In one embodiment, data storage 1122 may include one or more of added storage, user data, historical data and other data. The memory 1120 may store any other information suitable for use by computing device 1100 in providing the processor assisted weapon sight capability.

The communications interfaces 1130 include one or more services signaling interface such as a communications network interface and the like for supporting data/services signaling between computing device 1100 and an external communications and services infrastructure/network such as a battlefield communications network. It will be appreciated that fewer or more, as well as different, communications interfaces may be supported.

The I/O interface 1140 provides an interface to presentation interface(s) and user control interface(s) of computing device 1100.

The presentation interface(s) include any presentation interface(s) suitable for use in presenting information related to location-based data and services received at computing device 1100. For example, the presentation interface(s) 1142 may include a heads up display (HUD) interface adapted to provide imagery such as described herein with respect to the various figures.

The user control interface(s) 1144 include any user control interface(s) suitable for use in enabling the war fighter to interact with the computing device 1100. For example, user control interfaces(s) may include touch screen based user controls, stylus-based user controls, a keyboard and/or mouse, voice-based user controls, indications of changes to mechanical site adjustments (windage, elevation and the like) as well as various combinations thereof. The typical user control interfaces of computing devices, including the design and operation of such interfaces, will be understood by one skilled in the art.

Although primarily depicted and described as having specific types and arrangements of components, it will be appreciated that any other suitable types and/or arrangements of components may be used for computing device 1100. The computing device 1100 may be implemented in any manner suitable for enabling the processor assisted weapon sight capability described herein.

### Heads Up Display

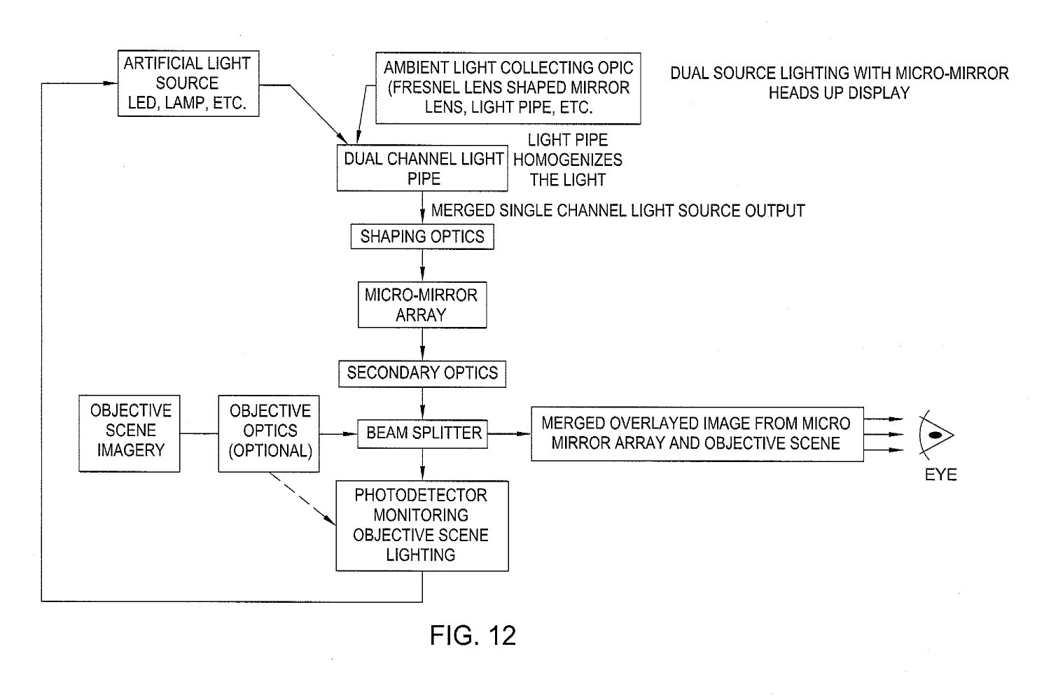

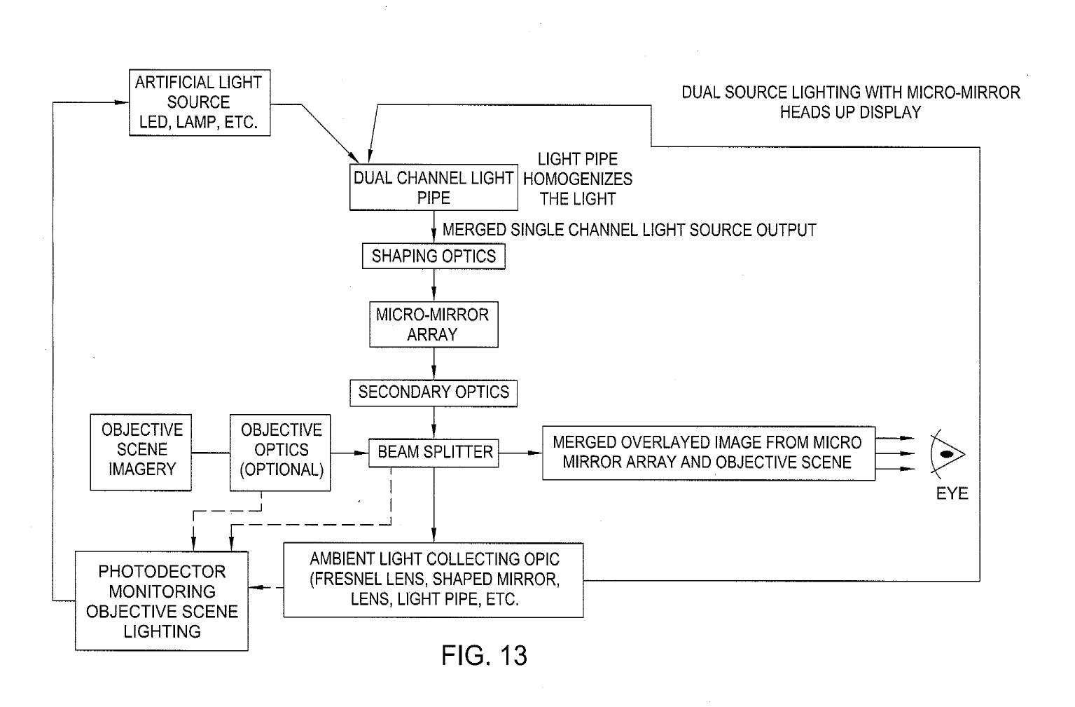

One embodiment of PAWS utilizes a direct view heads up display (HUD), which is generally described below and, in various embodiments, with respect to FIG. 12 and FIG. 13.

The heads-up display benefits from a high contrast display mechanism that can overlay tactical information onto the objective scene. One method discussed in this application is the use a digital micro-mirror array that can project high contrast ratio imagery into a beam splitter or similar device to achieve a fusion of the object scene with that of projected imagery injected from a micro-mirror array. The contrast ratio of these devices is upwards of 1000 to 1 and can provide for an effective means for the overlay display information to compete effectively in brightness with the natural illuminated objective scene. These arrays are semi-conductor based micro-electrical mechanical optical switches that are individually addressed, tiltable mirror pixels. These mirrors can have a broad reflectance spectrum that can extend from the near ultraviolet into the infrared. When an individual mirror is in the off-position light can be dumped optically to a beam dump so as to not add undesirable false bias illumination to the imagery from the object scene. The micro-mirror array can perform optical switching at speeds of more than 5000 times/sec. Typical mirror arrays from Texas Instruments come in a variety of resolutions including 1024×768 and 1440×1024.

Although the light source for the heads-up display can be a conventional artificial illumination source like a light emitting diode or semi-conductor laser, the invention has embodiments where a natural illumination source can be used to provide part or all of the light intensity needed for the heads-up display to operate. This natural lighting system has benefits of providing a potentially intense source of light at little or no electronic power expenditure. The natural lighting can be mixed and homogenized with artificial lighting through the use of a light pipe or similar mechanism and then provided to downstream shaping optics for presentation to the heads-up display imager, whether it is a micro-mirror array, a micro transmissive LCD display, or an alternative display technology.

Various embodiments provide a Direct View optical capability with an integrated heads-up display that is overlaid onto the optical scene to display an electronic reticule, tactical, status, imagery, and/or environmental information. The display can be color or monochrome. Display Information can be viewed with the relaxed eye so it appears part of the scene.

One mechanism for the heads-up display is the use of a MEMS micro-mirror array that can offer very high contrast ratios so as to provide an effective means for the overlay display information to compete effectively in brightness with the natural illuminated objective scene. In addition black areas of the overlay image don't add significant bias light to the objective scene since any light source illumination that is not needed at a particular spatial location can effectively be directed to a beam dump. The light source for overlay display can be a combination of artificial and natural lighting to reduce power requirements of the overlay display. The display has an electronic feedback mechanism to control the brightness of the artificial light source so as not to underwhelm or overwhelm the brightness of the overlaid display information with that of the natural scene.

In one embodiment, the display can use light from the actual scene being viewed so as to provide an optical feedback system that increases or decreases the intensity of the heads-up display in step with the illumination present in the scene itself.

In one embodiment, the heads-up display provides a high contrast display mechanism that can overlay tactical information onto the objective scene. Various embodiments use a digital micro-mirror array that can project high contrast ratio imagery into a beam splitter or similar device to achieve a fusion of the object scene with that of projected imagery injected from a micro-mirror array. The contrast ratio of these devices is upwards of 1000 to 1 and can provide for an effective means for the overlay display information to compete effectively in brightness with the natural illuminated objective scene. These arrays are semi-conductor based micro-electrical mechanical optical switches that are individually addressed, tiltable mirror pixels. These mirrors have a broad reflectance spectrum that can extend from the near ultraviolet into the infrared. When an individual mirror is in the off-position light can be dumped optically to a beam dump so as to not add undesirable false bias illumination to the imagery from the object scene. The micro-mirror array can perform optical switching at speeds of more than 5000 times/sec. Typical mirror arrays from Texas Instruments come in a variety of resolutions including 1024×768 and 1440×1024.

Various embodiments depicted herein provide some or all of the following features:
Substantially real time ballistic solution processing, wherein the computing device is continuously updating the ballistic solution and these updates can reflect changes or additions in the onboard, external, or inputted/received sensor and tactical information that is available.
Automatic in-flight tracer round detection and tracking, wherein information is processed automatically and provided as inputs to calculating the real time ballistic solution. Ballistic tracking results can be stored in a local onboard or remote database with other environmental and range information to be used for future ballistic reference. Automatic detection and processing of conventional rounds in flight using night vision imaging either through using an IR camera system or image intensifier.
Weapon pointing angle tracking using integrated high performance inertial sensors, thereby providing an ability to make precise pointing angle comparisons for advanced ballistic targeting and correction.
Integrated GPS and digital compass, wherein the weapon sight is capable of full coordinate target location and designation. The weapon sight may be capable of marking GPS locations within an object scene with range indicators. Similarly, the user can point the scope to a given object in the scene, determine the range to the object either manually, with laser range finding, parallax, or similar method and then mark its downrange GPS location in the weapon sight for local or external reference.
Integrated sensors for pressure, humidity, and temperature, wherein the weapon sight is capable of automatically incorporating this data in ballistic calculations.
Conventional rifle scope capabilities in all conditions, including zero-power off mode, wherein direct view passive optical sighting is preserved by the weapon sight.
Wired and/or wireless interfaces for communication of sensor, environmental, and situational awareness data, wherein the weapon site provides an ability to support digital interfaces such as Personal Network Node (PNN) and future interfaces such as Soldier Radio Waveform (SRW).
Anti-fratricide and situational awareness data can be processed by the device and viewed while sighting using the integrated head-ups display.
Built in passive optical range estimation capability with automatic angular to linear size conversion provided on heads-up display.
A weapon sight capable of aiming reticle (i.e., targeting) correction beyond scope's field of view for convenient ballistic drop correction at long ranges. The inertial sensors can provide an inertial reference, from which a simulated aim point reference can be created and placed on the overhead display. This aimpoint reference appears fixed in inertial space, but may be adjusted in real time by the system as a result of the continuous real time ballistic solution processing that occurs. This aimpoint reference can then be used for targeting in cases when the target cannot be seen in the field of view because the weapon is pointing in an extreme angular direction to satisfy the ballistic solution.
A weapon sight having integrated tilt sensitivity with respect to vertical, such that an integrated ballistic correction is provided for uphill and downhill shooting orientations. This capability is supported by, illustratively, the use of accelerometers or other devices within the weapon sight or associated with the weapon itself.
The ability to upload weapon, round, and environmental characterization data to the weapon sight using a standard computer interface.
An integrated imaging sensor that can be used for several purposes, such as target tracking, remote surveillance, target signature detection, target identification, mission documentation, and the like. In this manner, the weapon sight is capable of acquiring and processing target scene image frames.
The ability to record firing time history for purposes of applying cold bore/hot bore shot correction in an automated fashion.
The ability to monitor and display number of rounds fired by detecting the recoil acceleration signature of the weapon with the use of the PAWS onboard accelerometers and embedded processing.

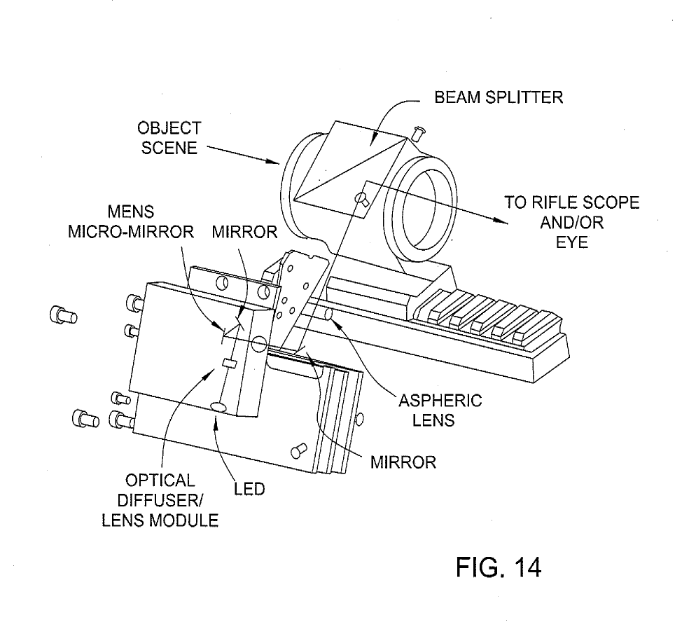

FIG. 14 graphically depicts an orthogonal view of a clip-on embodiment. Specifically, the PAWS clip-on embodiment provides a direct view heads up display overlaid onto a natural scene for users of existing riflescopes, such as the Trijicon ACOG riflescope. Various clip-on embodiments may be mounted in front of or behind an existing fixed or variable rifle scope.

In the embodiment of FIG. 14, a beam splitter (prism or plate) or a holographic waveguide is positioned in front of an existing riflescope. Text, graphics, and/or imagery is then projected through the existing rifle's scope (along with the received target imagery) using a display source (such as a micro mirror array, or micro LED display) and a combination of one or more lens, mirrors, beam splitters etc. into the overlaying optic (beam splitter, holographic waveguide, etc.). This optic then directs the display information into the front aperture of the existing riflescope. The optics can also be configured so the light enters the eye directly. The light that is injected into the front aperture of the riflescope is collimated so as to provide a relaxed eye direct view of the heads-up display information that is overlaid on top of the target/object scene when viewed from the rear of the riflescope (or with the naked eye directly). When a beam splitter is employed the reflected target/object scene port can be used to image both the object scene and the heads up display onto an imaging array so as to provide digital video or still photo capture and processing.

In one embodiment, the holographic waveguide is implemented using products such as the Q-Sight family of display related products manufactured by BAE systems.

This digital video capability supports tracking of target features and subsequent display of meta data results and designations on the overlaid heads up display. In this case, the data can be overlaid directly onto the scene targets and track with them as the targets and/or riflescope moves spatially. The heads up display may also be used to overlay direct imaging data from the video camera. It should be noted that the camera does not necessarily need to be located on the reflected object scene port.

With an onboard GPS combined with a magnetic compass, range finder, and/or inertial measure unit PAWS has the capability of designating targets and providing GPS locations of those targets. This information plus other information PAWS can collect including sensor and video information can be passed over a network to a battle command center or other PAWS enabled warfighters.

In one embodiment, input from one or more external devices is used to activate predefined functions. For example, in one embodiment a front grip of a rifle includes a switch that, when depressed, initiates a ranging function associated with a target proximate the reticle. In this manner, the war fighter may quickly range and ballistically engage each of a sequence of targets of various ranges without worrying about manual hold off and other targeting issues. The PAWS system performs the ranging associated functions so that the war fighter need only make a decision as to whether or not to engage.

Various embodiments have the ability to “team” with other PAWS devices to provide an anti-fratricide capability. In various embodiments, this is provided by the PAWS devices acquiring respective location data for each other and using a location data to define “no fire” zones or directions, identify or visually map other devices and so on. Various embodiments may also interoperate with external units and sensors over the network to acquire additional data that can be processed and presented to the warfighter so that better bathe decisions may be made.

PAWS and related embodiments enable one team member with a PAWS unit to designate a target using PAWS and then share that information over the network with a second PAWS unit, which may then ballistically engage the target.

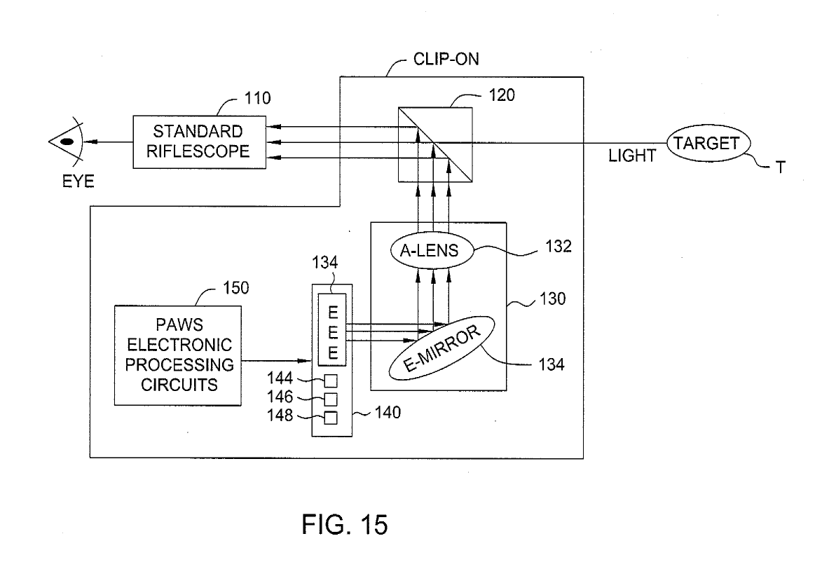

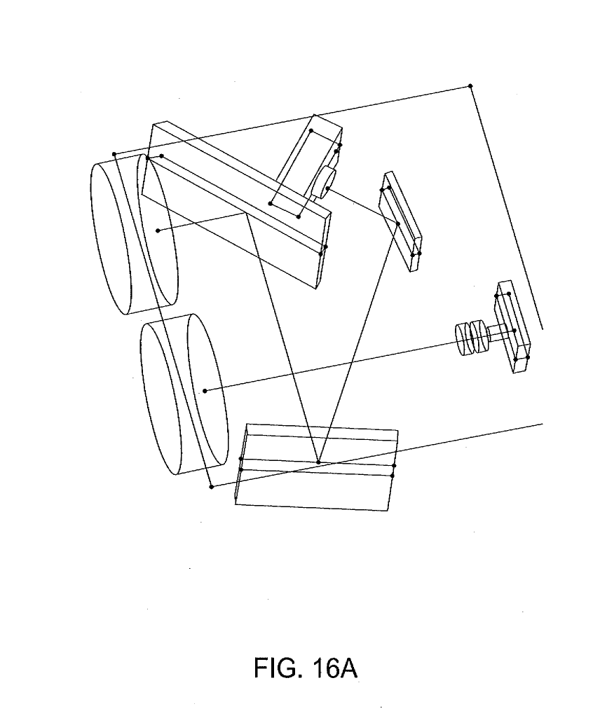

FIG. 15 depicts a high-level block diagram of a clip-on embodiment, such as described herein with respect to FIG. 14. Specifically, as can be seen in FIG. 15, a human eye is viewing light provided from a target T through a standard riflescope 110, such as an ACOG or other riflescope. The standard rifle scope operates in the normal manner to provide imagery of the target. The standard rifle scope is adjusted using the normal windage, elevation and other adjustments (not shown).

The light from the target passes through a PAWS clip-on embodiment mounted in front of the standard rifle scope (i.e., between the data rifle scope in the target). As previously noted, the clip-on embodiment may be mounted on a Picatinny Rail in front of the standard rifle scope. Advantageously, the PAWS clip-on embodiment provides heads up display information to the user of the data rifle scope without requiring any modification of the optics of the standard rifle scope.

The PAWS clip-on embodiment comprises a number of functional elements described herein with respect to the various figures. For purposes of simplifying the discussion, only a few of the functional elements will now be described with respect to FIG. 15, though other and various functional elements are contemplated by the inventor to be included in different embodiments.

Specifically, the PAWS clip-on embodiment shown in FIG. 15 comprises a beam splitter 120, a lens module 130 (comprising an aspherical lens 132 and an elliptical mirror 134), a micro mirror array head assembly 140 (comprising a digital light processor (DLP) micro mirror array 142, a diffuser 144 and an optical source 146 as well as related drive electronics 148), and various PAWS electronic processing circuits 150.

The beam splitter 120 is located between the standard rifle scope 110 and the target key, and allows light from the target T to pass directly through to the rifle scope 110. The beam splitter 120 also receives light from the aspherical lens 132, which light is directed toward the eye of the war fighter. In this manner, imagery generated by the PAWS clip-on embodiment is provided to the viewer along with imagery from the target, as described elsewhere herein.

The various imagery generated by various PAWS clip-on embodiments is defined as described herein with respect to the various figures. Referring to FIG. 15, it will be assumed that the PAWS-related imagery to be displayed to the war fighter is generated by the micro-mirror array 142 in response to control service provided by the PAWS electronic processing circuits 150. Specifically, the PAWS electronic processing circuits 150 communicate with the drive electronics 148 of the micro-mirror array head assembly 140. Light generated by the optical source 146 (illustratively a light emitting diode) is directed to the micro-mirror array 142 via the diffuser 144. Each element or mirror within the array of micro-mirrors is controlled to forward or not forward a respective portion of diffused light to the lens module 130. In this manner, PAWS related imagery is generated such as, for example, described above with respect to FIGS. 12-13.

The lens module 130 is depicted as including elliptical mirror 126 which redirects the light from the micro-mirror array 142 to the beam splitter 120 via the aspheric lens 124. The aspheric lens 132 operates to collimate light provided by the micro-mirror array 142. Elliptical mirror 134 is depicted as being disposed at a 45° angle with respect to the micro-mirror array 142 and a spherical lens 132 to provide thereby a circular aperture.

In one embodiment, the elliptical mirror 126 is not used. In this embodiment, light from the micro-mirror array 142 is injected directly into the aspheric lens 132 toward the beam splitter 120.

The lens module 130 may be formed using different optical components. Generally speaking, lens module 130 uses optics adapted to the optics of the standard rifle scope (e.g., 4×, 9×, 16× and so on). Generally speaking, the lens module 130 is adapted to change the size of the augmented reality imagery provided by PAWS to the viewer.

In one embodiment, the entire lens module 130 is field or armory replaceable depending upon the type of scope used (e.g., tactical combat rifle scope versus sniper rifle scope). Further, in the case of a variable magnification scope such as a 3×-9× scope, the lens module 130 may itself be variable. In one embodiment, the lens module 130 includes two or three lenses which are adapted in terms of their spacing based upon a cam or other mechanical actuators. In this embodiment, the lens module 130 may comprise a plurality of detents associated with each camp or other mechanical actuator such that the war fighter may dial-in several adjustments during initial sighting in of the scope. Each detent may be associated with a specific calibration point to enable rapid field adjustments.

In one embodiment, the PAWS clip-on embodiment is angled downward with respect to the standard scope and Picatinny rail such that the situational awareness of the war fighter is not diminished by a reduction in field of view due to the PAWS clip-on embodiment.

In one embodiment, a combination of optical and digital zooming is used. Specifically, assuming an optical zooming capability of 4× through 16×, additional zoom may be provided by adapting the augmented reality imagery provided by PAWS to the viewer. In one embodiment, the beam splitter comprises a front end to a holographic waveguide, such as in with respect to a heads up display (HUD).

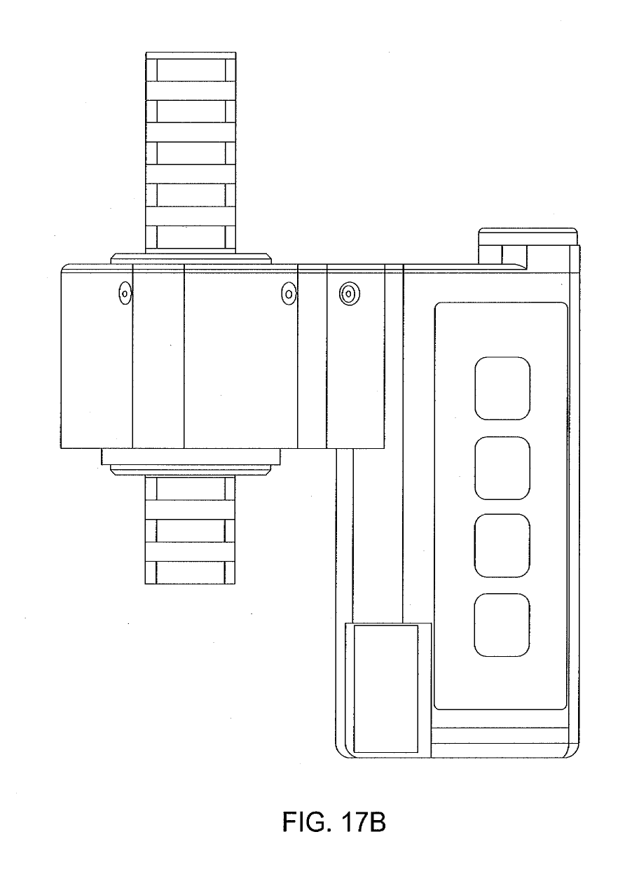

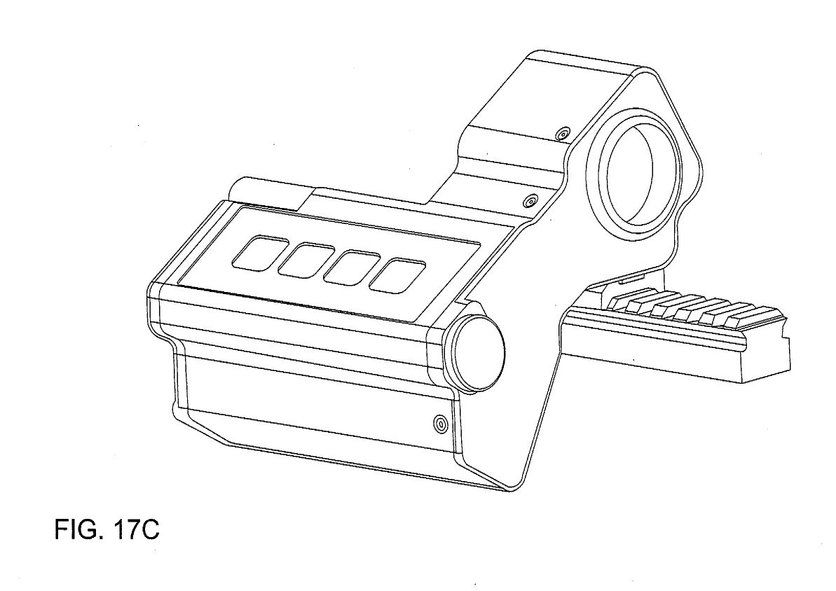

FIG. 17 provides several views of a PAWS clip-on device according to one embodiment.

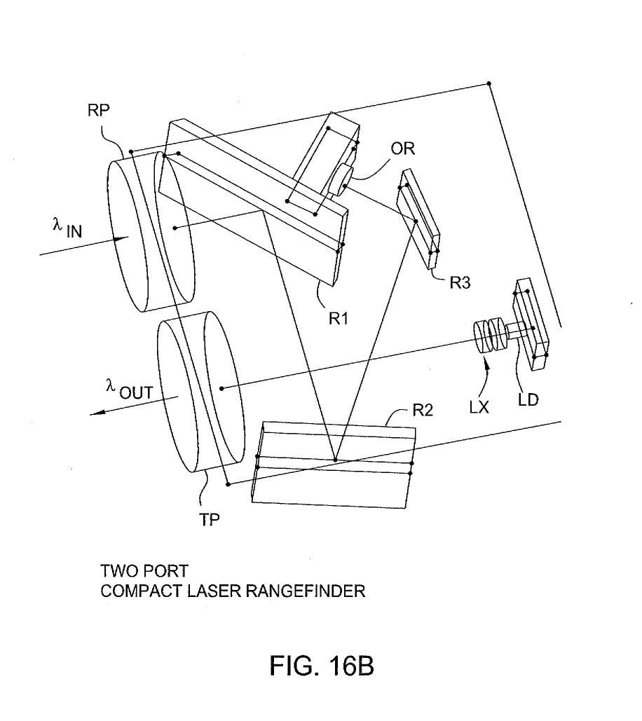

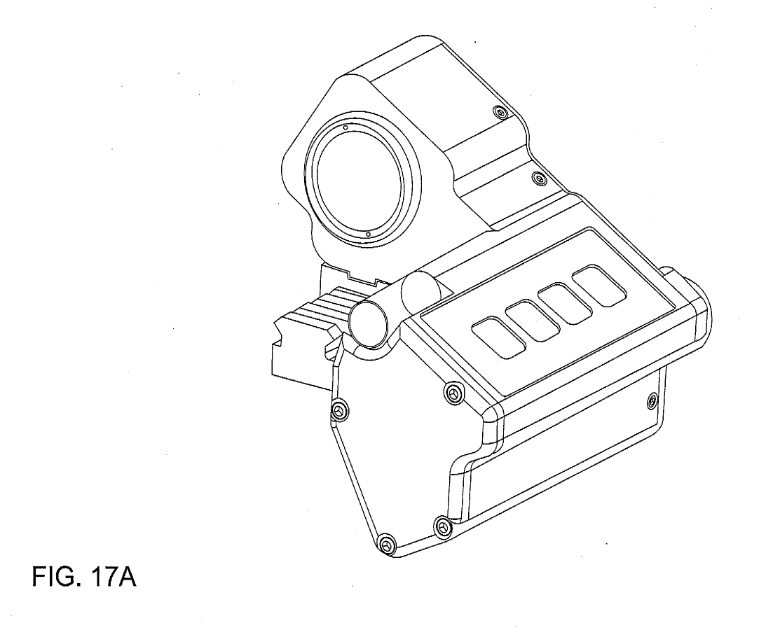

FIG. 16 depicts a laser range finding compact module according to one embodiment. The laser range finding compact module is a two port design in which a transmitting port is dedicated to transmitting a high intensity collimated beam of light λ_{OUT} towards a target, and a receiving port is dedicated to receiving reflected portions λ_{IN} of that light for subsequent processing to determine a range to the target.

Specifically, a laser diode LD (or other light source such as a conventional gas and/or solid-state laser) generates a high-intensity beam of light which is passed through a transmitting port objective lens TP. Optionally, one or more lenses LX proximate the laser diode operate with the objective lens TP to capture as much of the generated light as possible for propagation toward the target as the high intensity collimated beam of light λ_{OUT}. The high intensity collimated beam of light λ_{OUT} is eye-safe in one embodiment, and not eye-safe in other embodiments.

Reflected portions λ_{IN} of lights from the range to target are received via an objective lens RP at the receiving port. The receiving port employs a folded optical path that is constructed of one or more highly reflected mirrors that have their reflective surfaces tuned/fabricated so their peak reflectance is specifically centered around the wavelength of light that is being transmitted. The folded optical path of the receiving optics is such as to provide a long focal length optical capability to specifically collect light from a narrow field of view around the target area being ranged. The receiver can use an avalanche photodiode or similar detector. The f-number of the receiving/capturing optics is selected to capture as much light from the diode as possible.

In the embodiment of FIG. 16, three mirrors denoted as mirrors R1. R2 and R3 are used to provide a relatively long path for light to travel between the receiving port and optical receiver OR. It is noted that the compact laser rangefinder uses the same space to propagate light between the laser diode and transmitting port objective lens, and to propagate light between the various mirrors feeding the returned last reflected range beam to the optical receiver.

The compact laser range finder can be used as a standalone unit with range being communicated to other devices via a data port or displayed directly to a user. The compact laser rangefinder may also be used in conjunction with the PAWS clip-on device to provide range information directly to the heads up display or viewfinder of the weapon sight. The compact laser rangefinder may provide direct range data to PAWS to update the electronic targeting reticule in real time. In various embodiments, the laser range finding compact module is integrated into the standalone and/or clip-on PAWS systems described above.

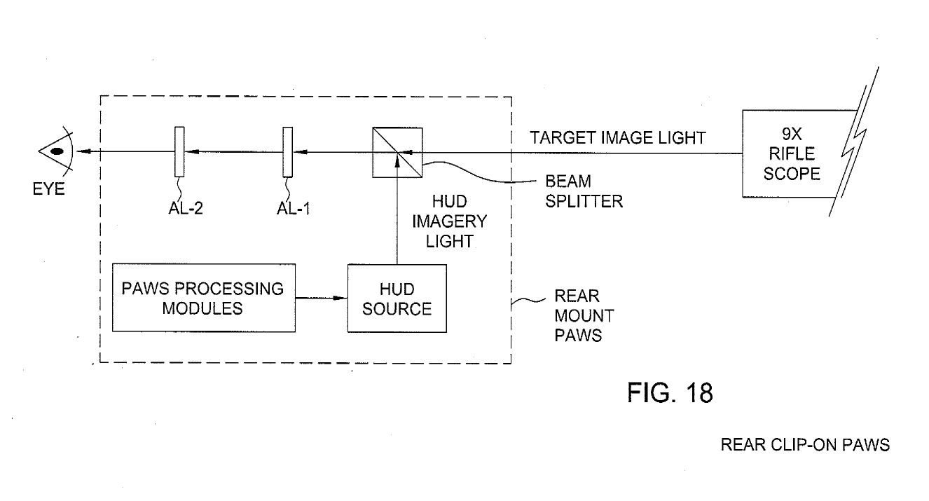

FIG. 18 depicts a high-level block diagram of a simplified rear mount/clip-on device according to one embodiment. Specifically, the embodiment of FIG. 18 comprises a rear mount of a Processor Aided Weapons Sight (PAWS) such as described herein with respect to the various figures. The rear mount or rear clip-on embodiment of the PAWS device of FIG. 18 operates in a substantially similar manner to the other embodiments described herein with respect to the various figures, except that the embodiment of FIG. 18 is mounted on a weapon behind an existing rifle scope (i.e., closer to the war fighter) rather than in front of existing rifle scope such as discussed above with respect to, illustratively, the front clip-on mounting of FIG. 17.

In the embodiment of FIG. 18, target image light exiting the rear of a rifle scope (illustratively an adjustable 3×-9× magnification scope) passes through a beam splitter and two sets of achromatic relay lenses before reaching a human eye. A heads up display (HUD) source provides HUD imagery light to the beam splitter, which in turn directs the HUD imagery light along the same path as the target image light; namely, through the two sets of achromatic relay lenses and into the human eye. PAWS processing modules provide the various graphic/imagery data projected by the HUD source as the HUD imagery light. The PAWS processing modules operate in substantially the same manner as described herein with respect to the various figures.

Within the context of the rear clip on embodiment of FIG. 18, the two achromatic lenses may have the same focal length or different focal lengths. In various embodiments the distance “d” between the two achromatic lenses is selected to be the sum of the focal length of two lenses.

The rear mount/clip-on device of FIG. 18 is positioned to maintain an afocal characteristic with respect to the rifle scope. That is, optics associated with the rear mount/clip-on device are mounted/positioned in such a manner as to optically occupy a position normally used by the human eye when viewing imagery directly through the rifle scope. By maintaining this afocal characteristic, there is no need to adjust the optics for different magnifications of the rifle scope, or even different scopes (other than normal scope siting operations). The optics of the rifle scope perform their intended function by delivering focused target image light to an appropriate point normally associated with the eye position of the war fighter. Similarly, rear mount/clip-on PAWS device is positioned at this appropriate point such that focused target image light is always being processed by the PAWS system.

Thus, one embodiment comprises a system in which a PAWS apparatus is mounted on a weapon to the rear of a rifle scope and maintaining an afocal characteristic as described above. The PAWS processing modules, HUD source and the like may be modified according to any of the other embodiments described herein with respect to the various figures. For example, the HUD source may comprise a digital light processor (DLP) device adapted to provide high resolution graphic imagery such as for a reticle's, environmental condition indicators, location indicators and so on.

In various embodiments, 25 mm achromatic lenses are used for the relay lenses. In other embodiments, larger or smaller a achromatic lenses are used. In various embodiments, aspheric lenses are used for the relay lenses. In various embodiments, the aspheric lenses are specifically adapted to reduce exit pupil artifacts and the like. Moreover, plastic aspheric lenses may also be used in some embodiments. Advantageously, the aspheric lenses may be adapted to reduce various physical dimensions associated with the PAWS apparatus.

In various embodiments, the beam splitter is replaced by a prism. In the case of a prism inducing target image inversion, the distance “d” between the achromatic lenses is adapted to compensate for the induced target image inversion of the prism. In some embodiments, such inversion is desirable. Different types of reflective optical prisms may be used within the context of the various embodiments. For example, roof prisms such as an Amici prism, Abbe-Koenig prism, Schmidt-Pechan prism, roof pentaprism and the like may be used. Depending upon the prism used, additional optical processing elements (e.g., lenses, beam splitter's and the like) may be used to adapt for additional optical axis.

In various embodiments, field of view calibrations are provided to enable improved optical matching between PAWS apparatus and rifle scopes, whether fixed magnification, adjustable magnification, night vision enabled and so on.

Generally speaking, various embodiments are directed towards reducing the size of the rear mount/clip-on device by, illustratively, adapting the optical devices in such a manner as to reduce the distance between the various devices. In addition, electronic circuitry and other components are also integrated or otherwise reduced in size to reduce the rear mount/clip-on device size (or the size of front mount/clip-on and or stand alone embodiments). Various embodiments of the rear mount/clip-on device provide a 2 inch length.

In one embodiment, packaging size is further reduced by locating a prism between the two relay lenses, whether achromatic or aspheric relay lenses. In one embodiment, the prism and one of the relay lenses are integrated into a single optical component. In various embodiments, the region between the relay lenses is primarily filled with air, while in other embodiments different gaseous and/or liquid media are used. In these embodiments, the optical characteristics of the selected media may be used to reduce the distance “d” between the relay lenses and, therefore, further reduce the size of the rear mount/clip-on device.

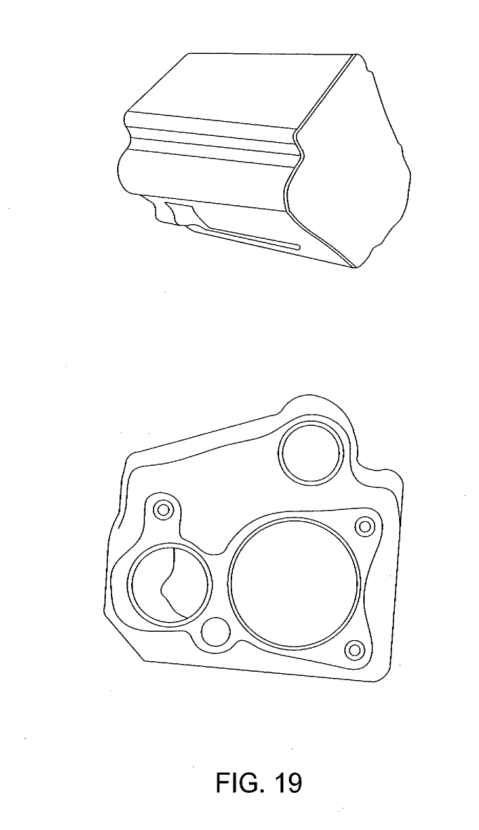

FIG. 19 provides several views of a PAWS rear clip-on device according to one embodiment.

Advantageously, as long as the rear mount/clip-on device is positioned in a manner maintaining the afocal characteristic with respect to the rifle scope (whether fixed or variable magnification), proper operation will result. This enables rapid replacement of the scope and/or the PAWS system by the war fighter with minimal recalibration.

Advantageously, various PAWS devices discussed herein are still useful even in the case of a loss of power since the target light from the rifle scope still reaches the eye of the war fighter. For example, in various embodiments the alignment of the optical components with respect to rifle scope and the war fighter means that only the HUD display information is lost.

Advantageously, various PAWS devices discussed herein preserve the exit pupil and eye relief characteristics associated with existing rifle scopes.

### Additional Fixed Magnification.

In various embodiments of the front or rear clip-on PAWS devices, an additional fixed optical magnification optic is provided, such as an additional 1.5× or 2× lens. In this manner, existing fixed 4×ACOG type rifle scopes may be converted into 6× or 8× fixed rifle scopes, thereby improving the effective range of deployed rifle scopes from approximately 500 yards out to approximately 800 yards.

### High-Power Pulsed Laser.

Various embodiments of the PAWS systems, methods and apparatus described above utilize laser range finding techniques. In some embodiments, a standalone laser range finding device is provided. In other embodiments, a front clip-on, rear clip-on or standalone PAWS system is provided in which a laser range finding module is used.

In various embodiments discussed herein, a laser range finding device or module utilizes a near infrared (NIR), 905 nm wavelength, pulsed laser operating at 75 W with a 100 ns pulse duration. While effective, this wavelength is dangerous to the human eye, and the components associated with these operating characteristics tend to be relatively large, such as a 40 mm receive aperture for use at eye-safe power levels.

In various embodiments, a laser range finding device or module utilizes a 1550 nm wavelength, pulsed laser operating at 50 KW with a 2.0 ns pulse duration. Advantageously, this wavelength is relatively safe to the human eye, and the components associated with these operating characteristics tend to be relatively small. For example, by using 50 kW pulses rather than 75 W pulses, the size of the receiver optics associated with the laser rangefinder may be reduced from 40 mm to 25 mm or less diameter. One embodiment of this higher powered laser range finding device is capable of identifying targets out to a range of approximately 1500 m while using a 25 mm diameter or less optical receiver aperture.

In various embodiments, field of view about a lased target, reduction in background radiation, contrast and the like are improved, such as by the use of a 905 nm blocking filter within the optical return path of the rangefinder.

FIG. 19 depicts laser rangefinder housing including three apertures, one each for the laser designator, the transmitter and the receiver.

### System Integration/Targeting

In one embodiment, the PAWS system provides inertial reference data, GPS data, laser range finding data and/or other target acquisition data pertaining to a target location such that the target location may be accurately mapped, such as to enable targeting via indirect weapon systems. That is, various embodiments provide a mapping or grid coordinate associated with the target location such that GPS-guided munitions or other munitions may be accurately directed to the target location.

In one embodiment, the war fighter generates target acquisition data of the target location from the perspective of two or more positions to provide, respectively, two or more sets of target acquisition data pertaining to the target location. The sets of target acquisition data may be further processed by the PAWS system itself or by another computing device (e.g., averaged, used to triangulate the target location, and so on).

It will be appreciated that the various embodiments, modifications to the embodiments and, in general, the teachings discussed herein with respect to FIGS. 18 and 19 may also be applied to embodiments described herein with respect to the other figures.

In a primary ammunition mode, various embodiments perform the above-described targeting calculations using parameters associated with a primary ammunition, illustratively the standard rifle rounds fired from the weapon upon which the weapon sight is mounted.

In a secondary ammunition mode, various embodiments perform the above-described targeting calculations using parameters associated with a secondary ammunition, illustratively grenade rounds such as used by a grenade launcher mounted upon the weapon upon which the weapon sight is mounted. That is, the computing device adapts the location of the aim point reticle in response to the ballistic characteristics associated with the secondary ammunition.

Within the context of a secondary ammunition mode associated with a grenade or other high trajectory device, some embodiments provide that an initial aiming reticle may be used within the context of initial target acquisition (e.g., target acquisition by a war fighter pressing a button while a reticle is displayed on a target), while a subsequent aiming reticle aiming reticle is projected upon the appropriate point in space calculated by the computing device to represent an appropriate aiming point for the secondary ammunition. In this embodiment, rapid acquisition of the subsequent aiming reticle may be facilitated by arrows or other directional imagery displayed to the war fighter via the heads-up display.

In the various ammunition modes, specific targeting information gathered in one mode that is useful for another mode is retained to promote computational efficiency, such as various environmental conditions, location information and the like.

Although various embodiments which incorporate the teachings of the present invention have been shown and described in detail herein, those skilled in the art can readily devise many other varied embodiments that still incorporate these teachings.

What is claimed is:

1. A weapon sight, comprising:
a beam splitter, for combining objective scene imagery received on a primary viewing axis with heads up display (HUD) imagery to produce a merged image for propagation towards a viewing point along the primary viewing axis;
a presentation device, for generating said HUD imagery; and
a computing device, for processing ballistics relevant data and responsively causing said presentation device to adapt an aiming reticle included within said HUD imagery.

2. The weapon sight of claim 1, wherein said presentation device comprises an imager formed using one of a micro transmissive LCD display and a MEMS micro-mirror array, the imager operatively coupled to said computing device and adapted thereby to provide said HUD imagery.

3. The weapon sight of claim 2, wherein said presentation device further comprises:
a source of artificial light; and
a dual channel light pipe for merging artificial light received at a first input and ambient light received at a second input to produce a merged output beam for propagation toward the imager.

4. The weapon sight of claim 3, further comprising a photo detector, for monitoring objective scene imagery light and responsively providing a control signal to the source of artificial light, said source of artificial light responsively adapting said artificial light to provide thereby a desired contrast ratio between said objective scene imagery and said HUD imagery.

5. The weapon sight of claim 3, wherein said photo detector is further responsive to at least a portion of said ambient light.

6. The weapon sight of claim 1, further comprising one or more of a global positioning system (GPS) receiver, a digital compass and a laser rangefinder for providing location data to said computing device, said computing device responsively using some or all of said received data to calculate a ballistic solution.

7. The weapon sight of claim 1, wherein said computing device receives one or more of inertial data, location data, environmental sensor data and image data, said computing device responsively using some or all of said received data to calculate a ballistic solution.

8. The weapon sight of claim 7, wherein said weapon sight is adapted to communicate with a network as a network element (NE), said computing device propagating toward said network some or all of said received data.

9. The weapon sight of claim 7, wherein in response to first user interaction, said computing device enters a ranging mode in which target related information associated with a presently viewed aiming reticle is retrieved and stored in a memory.

10. The weapon sight of claim 9, wherein in response to a second user interaction, said computing device enters a reacquisition mode in which previously stored target related information is retrieved from memory and used to adapt reticle imagery to reacquire a target.

11. The weapon sight of claim 1, further comprising a rangefinder for determining a distance to target and communicating the determined distance to said computing device, said computing device responsively adapting said aiming reticle in response to said determined distance.

12. The weapon sight of claim 11, wherein said rangefinder comprises one of a laser rangefinder and a parallax rangefinder.

13. The weapon sight of claim 11, wherein said laser rangefinder comprises a near infrared (NIR) rangefinder.

14. The weapon sight of claim 1, further comprising an imaging sensor adapted to detect image frames associated with a bullet flight path and communicate said image frames to said computing device, said computing device operable to calculate bullet trajectory therefrom.

15. The weapon sight of claim 14, wherein said imaging sensor is adapted to detect emissions within a spectral region associated with a tracer round.

16. The weapon sight of claim 1, further comprising windage and elevation knobs adapted to communicate respective user input to said computing device, said computing device responsively adapting said aiming reticle in response to said user input.

17. The weapon sight of claim 9, wherein in response to user interaction indicative of a specific, said computing device enters an indirect fire targeting mode in which target related information is retrieved from memory and used to adapt aiming reticle imagery to reacquire a target.

18. The weapon sight of claim 1, wherein in response to user interaction indicative of a secondary ammunition mode, said computing device responsively adapting said aiming reticle in response to ballistic characteristics associated with the secondary ammunition.

19. The weapon sight of claim 7, wherein said environmental data comprises one or more of barometric pressure data, humidity data and temperature data, said computing device responsively using some or all of said environmental data to calculate the ballistic solution.

20. The weapon sight of claim 1, wherein in the case of an aiming reticle outside an optical scope field of view, said computing device utilizes inertial reference information to generate for display a simulated aim point reference.

21. The weapon sight of claim 1, wherein in response to user interaction indicative of a surveillance mode, said computing device acquires and stores surveillance data associated with a target identified via the aiming reticle.

22. The weapon sight of claim 1, wherein the objective scene imagery is coincident with the merged image propagated towards the viewing point.

23. The weapon sight of claim 1, wherein the objective scene imagery is provided by an optical weapon sight integrated within the weapon sight.

24. The weapon sight of claim 1, wherein the objective scene imagery is provided by an external optical weapon sight mounted on a weapon in a manner optically cooperating with the beam splitter.

25. The weapon sight of claim 1, wherein the optical weapon sight is integrated therein.

26. The weapon sight of claim 1, further comprising a mount adapted to enable mounting of the weapon sight in a manner optically cooperating with a standard mount optical weapon sight.

27. A method, comprising:
combining objective scene imagery received on a primary viewing axis with heads up display (HUD) imagery to produce a merged image for propagation towards a viewing point along the primary viewing axis; and
adapting an aiming reticle included within said HUD imagery in response to ballistics relevant data associated with a target within said objective scene imagery.

28. A system for augmenting target environment information associated with an optical weapon sight, comprising:
a beam splitter, for combining objective scene imagery received on a primary viewing axis with heads up display (HUD) imagery to produce a merged image for propagation towards a viewing point along the primary viewing axis;
a presentation device, for generating said HUD imagery; and
a computing device, for processing ballistics relevant data and responsively causing said presentation device to adapt an aiming reticle included within said HUD imagery.
